(19) United States
(12) Patent Application Publication
(10) Pub. No.: US 2015/0275636 A1
(43) Pub. Date: Oct. 1, 2015

(54) Shielded Multi-Pair Arrangement as Supply Line to an Inductive Heating Loop in Heavy Oil Deposits

(71) Applicant: SIEMENS AKTIENGESELLSCHAFT, München (DE)

(72) Inventor: Dirk Diehl, Bubenreuth (DE)

(21) Appl. No.: 14/441,474

(22) PCT Filed: Oct. 24, 2013
(86) PCT No.: PCT/EP2013/072235

§ 371 Date: May 7, 2015

(30) Foreign Application Priority Data
Nov. 7, 2012 (DE) 10 2012 220 237.4

(51) Int. Cl. E21B 43/24; H05B 6/10

(52) U.S. Cl. CPC E21B 43/2401; H05B 6/10

(57) ABSTRACT

The invention relates to an arrangement of a plurality of electrical conductor pairs (3) for symmetrical supplying of a consumer, in particular of a capacitively compensated conductor loop for inductively heating deposits of substances comprising hydrocarbons, such as oil sand, bitumen, heavy oil, natural gas, shale gas, and a shield pipe (4) enclosing the substances, wherein supply (1) and return (2) lines of the conductor pairs (3) are alternatingly concentrically and/or uniformly distributed within the shield pipe (4) enclosing the plurality of conductor pairs (3). The eddy currents occurring in the shield pipe (4) and the consequential losses are thus minimized.

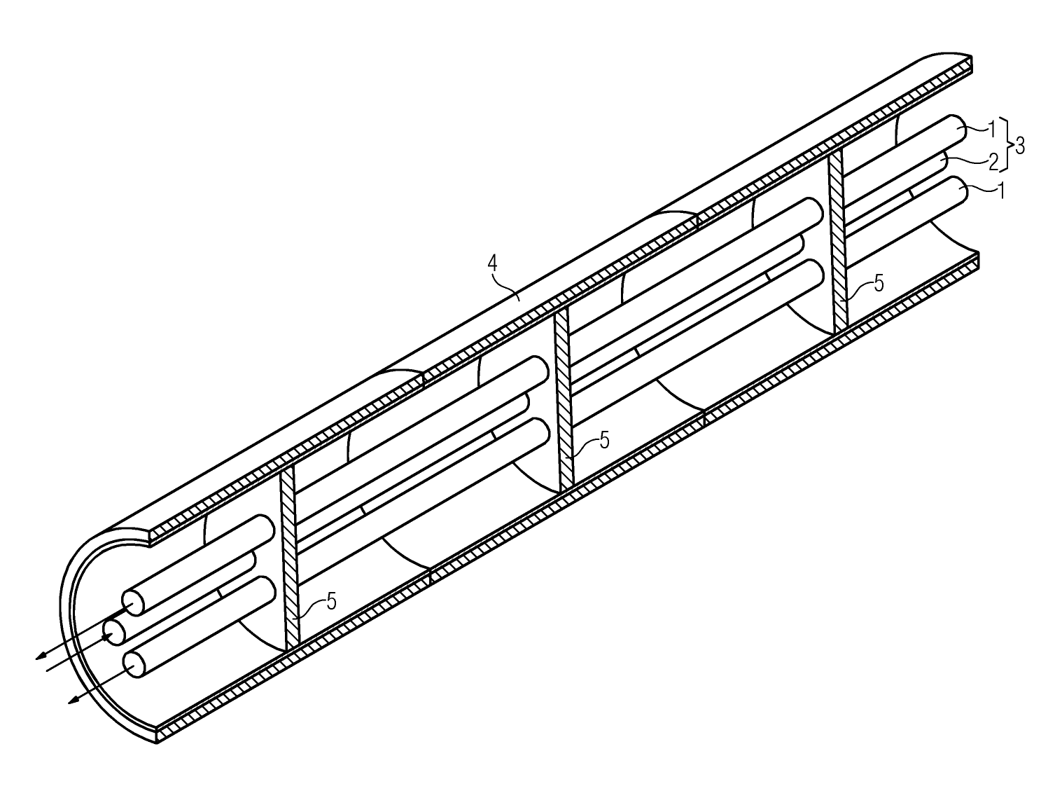

Shielded multi-pair arrangement as supply line to an inductive heating loop in heavy oil deposits

The invention relates to an arrangement of a plurality of electrical conductor pairs for symmetrical supplying of a consumer.

For the extraction of heavy oils or bitumen from oil sand or oil shale deposits by means of pipe systems which are introduced therein by means of bore holes, the fluidity of the oils must be significantly increased. This can be achieved by increasing the temperature of the deposit and/or reservoir, for example, by means of a Steam Assisted Gravity Drainage (SAGD) method.

With the SAGD method, steam—to which solvents may be added—is injected under high pressure through a pipe running horizontally within the reservoir. The heated, molten bitumen freed of sand or stones seeps to a second pipe approximately 5 m deeper, through which the liquefied bitumen is extracted. The steam must perform a plurality tasks simultaneously, namely the introduction of heat energy for liquefaction, the removal of sand and the build-up of pressure in the reservoir, in order on the one hand to make the reservoir geomechanically permeable for bitumen transport (permeability) and on the other hand, to enable the extraction of bitumen without additional pumping.

In addition to the SAGD method or instead of it, induction heating for the support or extraction of extra-heavy oils or bitumen can be used. Such induction heating is disclosed in the printed publication DE 10 2008 044 953 A1. Electromagnetic induction heating consists of a conductor loop which is laid in the reservoir and when energized induces eddy currents in the surrounding soil which heat this. In order to attain the desired heat output densities of typically 1-10 kW per meter of length of an inductor—depending on the conductivity of the reservoir—it is necessary to impress currents of a few 100 Ampere for typical frequencies of 20-100 kHz. For the compensation of an inductive voltage reduction along the conductor loop, capacities are interposed as a result of which a series-resonant circuit arises which is operated at its resonance frequency and represents a purely ohmic load at the terminals. Without these series capacitors, the inductive voltage reduction of the conductor loop, which is up to several 100 m long, would accumulate a few 10 kV to more than 100 kV at the connection terminals, which is scarcely manageable inter alia with regard to insulation from the soil.

Furthermore, the idle power would have to be compensated on or in the generator.

In DE 10 2008 062 326 A1 it is proposed that two or more conductor groups be connected capacitively in periodically repeated sections of a defined length (resonance length). Each conductor is individually insulated and consists of a single wire or a multiplicity of wires each insulated in turn. In particular, a so-called multifilament conductor structure which was already suggested for other purposes in electrical engineering is formed. If appropriate, a multiband and/or multi-foil conductor structure can also be realized for the same purpose.

Regardless of the type of capacitively compensated inductor used, transferring the heat output from the generator and/or frequency converter, which is preferably positioned on the surface of the ground and/or sea, to the conductor loop in the reservoir with minimal loss is problematic.

An additional problem is posed by penetration of the overburden by supply pipes which must take place in such a way that fluids from the reservoir cannot under any circumstances reach the surface in an uncontrolled manner. This is also known as caprock integrity.

A problem is also posed by the strain from mechanical and hydraulic external pressure which the onshore and offshore supply line must withstand, in particular in the case of reservoirs located at a depth of more than 1000 m, which is equivalent to pressure of in excess of 100 bar.

Until now it has been largely assumed that the conductor loop is connected to a converter via a capacitively compensated inductor line. Losses in the overburden can be largely avoided by laying the supply and return lines in parallel and at a short distance from each other, e.g. <5 m), as long as there is no metallic, and in particular, no ferromagnetic shielding/enclosure of each individual inductor arm—supply and/or return line—as substantial losses would otherwise occur in these as a result of eddy currents and hysteresis. Such a restriction in the material of the bore hole lining in particular prohibits the use of otherwise customary steel pipes e.g. with SAGD. Plastic pipes for bore hole lining and wellheads made of plastic, e.g. GRP (Glass Reinforced Plastic), which can be manufactured in principle but are costly and currently uncertified, would therefore be required.

For example, in U.S. Pat. No. 1,625,125 A an electrical conductor pair is disclosed that is divided into a plurality of conductor pairs, wherein the supply and return lines of the conductor pairs are alternatingly concentrically and/or uniformly distributed to reduce self-induction in conductors of a power transmission line.

The execution of a connection as a coaxial transmission line is also known. The output voltage of a converter is supplied between the inner and outer conductor of the coaxial transmission line in order to penetrate the overburden. In the reservoir the inner and outer conductor are separated from each other in a Y-shape in order to form the two arms of the inductor and joined together at the opposite end still in the reservoir in order to close the conductor loop. Due to the symmetrical supply, however, an outer casing of the coaxial transmission line cannot be connected to ground potential and therefore requires electrical outer insulation. With such an arrangement, no magnetic fields occur outside the coaxial conductor and therefore no eddy current losses in the overburden either. In addition, the coaxial transmission line with electrical outer insulation can also be encased in a steel pipe which is cemented into the overburden to ensure sealing from the reservoir. Furthermore, standard steel wellheads can be used. A disadvantage, however, is the necessity for outer insulation. On the one hand, this can result in electrical failures which lead to flashovers at the wellhead or bore hole lining, on the other hand, fluids could reach the surface from the reservoir through an annular gap between the outer insulation and the surrounding bore hole lining if a seal fails. This risk is increased by the fact that damage occurs and/or contamination is introduced when the coaxial cable is introduced into the bore hole lining under real conditions.

A conductor arrangement is known from DE 16 15 041 A in which individual strands of three separately insulated phase conductors within a pipe are insulated from each other with the aid of a fluid and for which supporting rings made of a ceramic material or another good insulating material are provided at predetermined intervals to ensure an essentially uniform distance between the phase conductor strands and the pipe.

Based on the prior art, the task of the invention is to create a suitable device and/or conductor arrangement for supplying electrical and/or electromagnetic heating of a reservoir of a heavy oil and/or oil sand deposit which minimizes environmental risks and can be efficiently operated.

This object is achieved by means of an arrangement of a plurality of electrical conductor pairs for symmetrical supplying of a consumer—in particular of a capacitively compensated conductor loop for the induction heating of deposits of substances comprising hydrocarbons such as oil sand, bitumen, heavy oil, natural gas, shale gas—and a shield pipe enclosing the substances, wherein supply and return lines of the conductor pairs are alternatingly concentrically and/or uniformly distributed within the shield pipe enclosing the plurality of conductor pairs. The conductors are preferably distributed at a predefined distance radially and evenly over the circumference, wherein a supply and return line of a conductor pair are arranged alternatingly. The conductors are preferably arranged opposed to each other. The distance of shell surfaces of two conductors to each other is, for example, at least as great as the diameter of one of the conductors. By fully including the electrical field in the conductor structure, the electrical insulation of the shield pipe can be omitted from the surrounding soil for onshore application and/or from the surrounding sea water for offshore applications.

The arrangement of supply and return line pairs results in symmetrical conduction which is ideally suited to transmitting the output voltage symmetrical to the ground potential of the generator to a conductor loop—this applies, in particular, when using an insulating output transformer with a grounded center tap. The higher the number of supply and return line pairs with the described alternating arrangement is, the faster the electrical and magnetic fields surrounding them fall off outwards towards the shield pipe. The currents occurring in the shield pipe and the associated losses are therefore lower. Furthermore, conductors with rounded, sector-shaped conductor cross sections are used. By this means, higher capacitances and consequently lower line impedances can be achieved without increasing the electrical maximum field strength.

This can be used to reduce the conductor cross-section dimensions, and/or extend the range of achievable line impedances downwards without increasing the dielectric strength requirements.

In an advantageous embodiment, the conductor cross sections are hollow. As a result, weight can be saved and better use made of the conductor cross-section at high frequencies—here up to 200 kHz.

Depending on the mechanical and electrical operating condition requirements, insulation acting as a dielectric between the conductors may be selected made of plastic or ceramics or as a fluid. Solid dielectrics such as those made of plastic or ceramics have the advantages that they support the conductors simultaneously and seal the line against the perfusion of fluids from the reservoir, whereby caprock integrity is maintained. Gases as dielectrics have the advantage that they permanently withstand high temperatures. Some silicon or synthetic oils can also be used as dielectrics at high temperatures of or in excess of 300° C. Liquid or gaseous dielectrics have the advantage that they do not oppose the bending of the line and their electrical strength is maintained. It is also advantageous compared with a gas charge, for example, that oil used as a dielectric can build up hydrostatic pressure on account of its specific weight, which corresponds to approximately that of the surrounding soil. An outer conductor would therefore be supported by the internal pressure of the oil.

In another advantageous embodiment supporting rings are provided at predetermined intervals for support and/or guidance of the conductors in the shield pipe. The supporting rings are required to hold the conductors in the shield pipe in position and simultaneously ensure the longitudinal leak tightness of the line. In the case of liquid dielectrics, however, small apertures would be necessary in the supporting rings, by means of which an outer conductor can be supported by the internal pressure of the oil.

In a particularly practical embodiment, the conductors or conductor pairs in the shield pipe are arranged in the form of a helix. The guidance of the conductor pairs as a helix is advantageous when laying in curves as it enables longitudinal compensation of inner and/or outer curves. Furthermore, a further reduction in electromagnetic radiation can also be achieved by this means.

The conductors and/or the shield pipe are advantageously made of highly electrically-conductive and non-ferromagnetic material (for example, aluminum) in order to reduce and/or avoid ohmic losses and magnetic hysteretic losses.

Additional advantages result from embodiments in which the shield pipe is designed concentrically in multiple layers. Insofar as the innermost layer is made of a good electrical conductor, e.g. aluminum, the ohmic losses can be reduced. Hysteretic losses are avoided by means of non-ferromagnetic conductor material. Even an innermost conductor layer a few millimeters thick, e.g. 3-5 skin penetration depth, is sufficient to ensure sufficiently high electromagnetic shielding. An additional layer, for example of steel, can ensure the required mechanical stability. If necessary, additional plastic coatings can be applied as anti-corrosion protection, which may be necessary for offshore applications in particular.

Further details and advantages of the invention result from the following figure description of and the associated exemplary embodiments.

The single FIGURE shows a perspective view of a section through the longitudinal axis of a conductor according to an embodiment of the invention.

In the single FIGURE a plurality of supply lines 1 and return lines 2 of an embodiment of an arrangement of a plurality of electrical conductor pairs 3 for symmetrical supplying of a consumer—not shown—within a shield pipe 4 enclosing them are shown. A supply and return line 1, 2, form a conductor pair 3, wherein a plurality of conductor pairs 3 are arranged in such a way in the enclosing shield pipe that the individual supply and return lines 1, 2 are alternatingly concentrically and/or uniformly distributed within the shield pipe 4. In the present exemplary embodiment three of a total of 6 conductors 1, 2 are shown, each of which form three conductor pairs 3 which are distributed at an approximately equal distance over the circumference of a circle and are separated from each other by equal distances. By this means the negative electrical and magnetic field influences are minimized due to the currents flowing in the conductors 1, 2 and/or conductor pairs 3.

In a particularly preferred embodiment, the number of supply 1 and return line 2 pairs 3 is increased for the alternating arrangement described as the electromagnetic fields surrounding them therefore weaken particularly rapidly outwards towards the shield pipe 4. The eddy currents forming in the shield pipe 4 and the associated losses therefore decrease.

In the present exemplary embodiment a fluid—for example a gas such as nitrogen or SF₆ and/or a liquid such as transformer or silicon oil is provided as insulation and/or a dielectric between the conductors 1, 2. Liquid or gaseous dielectrics have the advantage that they do not resist a bend in the line and their dielectric strength is maintained. However, at certain intervals, for example at one to twenty meters, supporting rings 5 are required which keep the conductors 1, 2 in position and simultaneously ensure the longitudinal leak tightness of the line. Gases as dielectrics have the advantage that they permanently withstand high temperatures. Some silicon or synthetic oils can also be used as dielectrics at high temperatures of around or in excess of 300° C.

In a further embodiment of the invention, for example, instead of a gas charge oil is used, which can build up hydrostatic pressure due to its specific weight which corresponds to approximately that of the surrounding soil. An outer conductor can therefore be supported by the internal pressure of the oil, for which small apertures must be provided in the supporting rings 5.

In a particularly advantageous embodiment consecutively distributed supporting rings 5 are constantly slightly rotated against each other, wherein the individual conductors 1, 2 and/or conductor pairs 3 form a helix. By guiding the conductor pairs 3 as a helix, these can be laid in curves particularly advantageously to offset the length of inner and/or outer curves. Furthermore, such “twisting” offers a further reduction in particular of the electromagnetic radiation of the conductors 1, 2.

The shield pipe 4 enclosing the conductor pairs 3 can be connected to ground potential, and/or may be laid through soil and/or sea water without electrical insulation. For the operating frequencies in the range of 10-200 kHz used here, which are high in comparison to the network frequency, grounding by means of a capacitive short circuit is also ensured if a thin, e.g. 0.5 mm thick plastic external coating is applied as anti-corrosion protection. This results in significant advantages compared with a physically more separated and unshielded laying of supply and return lines 1, 2, as they are known from the prior art.

The conductor pairs 3 incl. the shield pipe 4 can be guided through a standard steel wellhead as there are no electromagnetic fields outside the shield pipe. Otherwise, the electromagnetic fields would result in an undesirable and inadmissible heating of a steel wellhead, or necessitate an electrically non-conductive and non-ferromagnetic wellhead, for example made of plastic. However, wellheads made of plastic are not currently being developed.

Furthermore, laying of the shielded conductor pairs 3 through a bore hole, for connection between the surface and reservoir, can be performed in the customary manner with a concrete seal as no electromagnetic fields occur outside the line. The outer shield pipe 4 can be treated in the same way as other pipelines usual in the oil & gas industry. The required impermeability can thus be ensured, which is imperative for the approval procedure of the method.

A field-free and thus loss-free exterior space is an advantage in particular when creating a transit through sea water as the electrical conductivity of the salt water of approx. 5 S/m is many times higher, approx. 10-1000 times higher than with an overburden for onshore applications. The transit of an unshielded inductor cable through sea water would result in correspondingly higher and possibly no longer acceptable electrical losses which can be avoided with the shielded multi-pair line 3.

This multi-pair shielded line 3 connects a capacitively compensated conductor loop which is laid in the reservoir to a power generator, e.g. converter—not shown—on the surface. To this end, all the supply lines 1 are joined together and laid on an output terminal of the generator and all the return lines 2 are also joined together and laid on the other output terminal of the generator. In the same manner, at the other end of the supply line in the reservoir all the supply lines 1 are laid on a branch of the conductor loop and all the return lines 2 on the other branch of the loop. Usually, the power on the converter is disconnected via an output transformer for electrical insulation and voltage adjustment of the load. Advantageously, an output transformer with a center tap can be used. The center tap can be placed on the shield pipe 4 for grounding, wherein at the operating frequency capacitive grounding is also available when the shield pipe 4 is enclosed by an electrically insulating coating, for example plastic, a protective coating, etc. Wave impedance of the conductor pairs 3 can be determined by means of corresponding cross-section design, i.e. pipe diameter and pipe distances as well as distance from the shield pipe 4, and a choice of the dielectric in broad ranges, e.g. 1-500 Ohm. This occurs adjusted to generator and load impedance and the electrical length of the conductor pairs 3. With the grounded center tap on the output transformer, a symmetrical output voltage is ensured. This is important in order to keep the shield pipe 4 and all the associated operating material, e.g. a wellhead, reliably on ground potential.

If a compensated inductor cable—as is the case here—is itself directly connected to the output transformer of the converter, an impedance adjustment must be ensured by the output transformer alone. However, if—as described here—a transmission line is used for the connection of the generator, converter and possibly also output transformer to the conductor loop in the reservoir, this can be used additionally or alternatively as a line transformer. To this end, the line impedance (Z) must be selected appropriately: Z_line=sqrt(Z_generator*Z_load). The operating frequency of the conductor loop must be adjusted to the electrical length of the shielded multi-pair supply 3 such that a λ/4 and/or (2*n+1)* λ/4, with n=0, 1, 2, . . . transformation is obtained. Other transformations, which also include some of the idle power compensation of the conductor loop, can also be obtained.

1. An arrangement of a plurality of electrical conductor pairs (3) for symmetrical supplying of a capacitively compensated conductor loop for induction heating and a shield pipe (4) enclosing them, wherein
supply (1) and return (2) lines of the conductor pairs (3) are alternatingly concentrically and/or uniformly distributed within the shield pipe (4) enclosing the plurality of conductor pairs (3) and the supply (1) and return (2) lines each has a circular sector-shaped cross-section.

2. The arrangement as claimed in claim 1, characterized in that the cross-section of the conductor is hollow.

3. The arrangement as claimed in claim 1 or 2, characterized in that insulation acting as a dielectric between the supply and return lines (1, 2) is plastic or ceramic or a fluid.

4. The arrangement as claimed in one of claims 1 to 3, characterized in that supporting rings (5) can be provided at predetermined intervals for support and or guidance of the conductors (1, 2) or conductor pairs (3) in the shield pipe (4).

5. The arrangement as claimed in one of claims 1 to 4, characterized in that the conductors (1, 2) or conductor pairs (3) in the shield pipe (4) are arranged in the form of a helix.

6. The arrangement as claimed in one of claims 1 to 5, characterized in that the conductors (1, 2) and/or the shield pipe (4) are made of a diamagnetic or paramagnetic material.

7. The arrangement as claimed in one of claims 1 to 6, characterized in that the shield pipe (4) is designed concentrically in multiple layers.

8. The arrangement as claimed in claim 7, characterized in that an external layer of the shield pipe (4) is an insulation layer.
